(19) United States
(12) Patent Application Publication
(10) Pub. No.: US 2010/0123316 A1
(43) Pub. Date: May 20, 2010

(54) POWER GENERATOR BARGE

(76) Inventor: Benjamin P. FOWLER, Houston, TX (US)

Correspondence Address: EGBERT LAW OFFICES, 412 MAIN STREET, 7TH FLOOR, HOUSTON, TX, 77002, US

(21) Appl. No.: 12/365,686

(22) Filed: Feb. 4, 2009

Related U.S. Application Data
(60) Provisional application No. 61/115,863, filed on Nov. 18, 2008.

(51) Int. Cl. F03B 13/00

(52) U.S. Cl. 290/54

(57) ABSTRACT

The present invention is a power generator barge, including a boat body, generator, paddle wheel cam, deflector and cables. The boat body has a plurality of rotational mounts and cable anchors on opposite ends thereof. A generator is mounted on the rotational mounts by a rotatable shaft. The rotatable shaft is operatively connected to the generator such that when the shaft rotates, the generator generates electricity. The paddle wheel cam fixedly attaches to an end of the rotatable shaft and is positioned against the boat body so as to be capable of rotation in the water. Water flow is directed to the paddle wheel cams along the side of the boat body by the deflector, and the cables maintain the fixed position of the power generator barge. The present invention provides a power generator barge for providing a small hydro system of electricity to isolated peoples living near moving water.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to apparatus for generating electrical energy. More particularly, the present invention relates to apparatus for generating electrical energy from the action of water. Furthermore, the present invention relates to mobile devices for producing hydraulic energy for small communities.

2. Description of Related Art Including Information Disclosed Under 37 CFR 1.97 and 37 CFR 1.98

Hydroelectric power can be developed on a scale in order to serve a small community, such power generation is referred to as small hydro or micro hydro. This scale of operation provides of hydroelectric power sized for small communities, single families or small industrial applications. These small hydro projects have particular application in isolated areas, where it would be uneconomic to serve from a larger power network. Outlying communities and isolated peoples will have their only access to electricity from these types of small hydro projects. For example, remote Chinese villages along the Yangtze River are downstream from the Three Gorges Dam and could still benefit from small hydro. Furthermore, small hydro requires little construction and has a relatively low environmental impact compared to large scale hydroelectric power plants.

Hydroelectric power is the generation of electric power from flowing water. A hydroelectric system requires a dependable flow of water. In a typical installation, water is fed through a channel or pipe into a turbine. The pressure of the flowing water on the turbine blades causes the shaft to rotate. The rotating shaft is connected to an electrical generator which converts the motion of the shaft into electrical energy. Small hydro is hydroelectric power on a smaller scale with direction application on downstream rivers, typically after a large hydroelectric system.

Small hydro systems use specifically-designed turbines or reversed industrial centrifugal pumps, which act as turbines. For a small hydro system, the machines rarely have optimum hydraulic characteristics, such that low cost turbines are attractive for small hydro class installations. The need for efficiency is reduced because of the small scale and smaller power demands placed upon the system.

Regulation of small hydro generating units usually require diversion of water around the turbine. The control of water flow affects the small hydro power generation process. Other small hydro systems, such as tidal energy turbines, are completely immersed in flowing water to extract energy. With the ocean in mind, tidal schemes may require water storage or electrical energy storage to account for intermittent wave activity, such that exactly predictable flow of power is not really possible.

In the past, various patents have issued for these water-based energy systems. For example, U.S. Pat. No. 7,352,078, issued on 1 Apr. 2008 to Gehrig, discloses an offshore power generator positioned in the ocean. Ocean current, wind, waves and other renewable energy generators are mounted to the offshore platform. Each current generator has a shroud enclosing a set of blades. A hub member is located within the shroud and extends in an upstream direction from the blades. The flow area between the interior of the shroud and the hub member converges from the shroud inlet to the blades.

U.S. Pat. No. 6,766,643, issued on 27 Jul. 2004 to Christensen, describes a wind and wave energy plant, having a windmill portion with a rotor and a wave-actuated water pump. The pump drives a turbine whose output shaft is in driving connection with an electric generator. The windmill includes a tubular mill tower, which is anchored to the seabed and encloses a storage tank between the sea surface and the mill rotor. The storage tank can be filled with water by means of the pump via a non-return valve. This water flows to the turbine for the generation of power.

U.S. Pat. No. 6,194,791, issued on 27 Feb. 2001 to Wells, describes a wave collector structure for electrical power generation powered by wave energy. There is an outwardly extending and downwardly depending lip, having a mouth positioned below the collector. There are also side walls for channeling waves into the collector mouth and for extending horizontally substantially up to or beyond the lip. Water is enclosed to the lip and side walls, such that this reservoir is used to generate power.

U.S. Pat. No. 5,549,445, issued on 27 Aug. 1996 to Schremp, serves to disclose another system for using turbines placed in water to be driven by waves. The spinning turbines generate the usable power. There is an additional wind energy generator incorporated on the device of this prior art invention.

It is an object of the present invention to provide an apparatus for generating electrical energy relative to the action of water.

It is another object of the present invention to provide a hydraulically powered generator apparatus which is portable and easily installed.

It is another object of the present invention to provide a small hydro system with paddle wheel structures.

It is still another object of the present invention to provide a small hydro system with a deflector system to account for the alternative paddle wheel structures.

These and other objects and advantages of the present invention will become apparent from a reading of the attached specification and appended claims.

### BRIEF SUMMARY OF THE INVENTION

The present invention is a power generator barge, comprising a boat body, generator, paddle wheel cam, deflector and cables. The boat body has an interior volume with a plurality of rotational mounts and cable anchors on opposite ends thereof. A generator is mounted on the rotational mounts by a rotatable shaft. The rotatable shaft is operatively connected to the generator such that when the shaft rotates, the generator generates electricity. The present invention includes a paddle wheel cam fixedly attached to an end of the rotatable shaft. The paddle wheel cam extends along a side of the boat body and is positioned against the boat body so as to be capable of rotation. The paddle wheel has a diameter that allows contact with the water surface, driving the paddle action of each paddle wheel.

The boat body includes a deflector being attached to an end of the boat body facing a direction of the water current. The water flow is directed to the paddle wheel cams along the side of the boat body. A plurality of cables maintain the fixed position of the power generator barge. Each cable has ends attached to the cable anchors of the boat body and opposite ends attached to an anchor. The anchor can be sunken in the water or maintained on shore.

The present invention provides a power generator barge for providing a small hydro system of electricity to isolated peoples living near moving water. The transport and assembly are made easier by the seaworthiness of the barge. Under-served areas can receive power with minimal disruption to the environment and surroundings and minimal instruction for installation of the barge.

### BRIEF DESCRIPTION OF THE SEVERAL VIEWS OF THE DRAWINGS

FIG. 1 is a schematic view of the power generator barge of the present invention, as shown from the top.

FIG. 2 is a side schematic view of the power generator barge of the present invention, showing placement in the water.

### DETAILED DESCRIPTION OF THE INVENTION

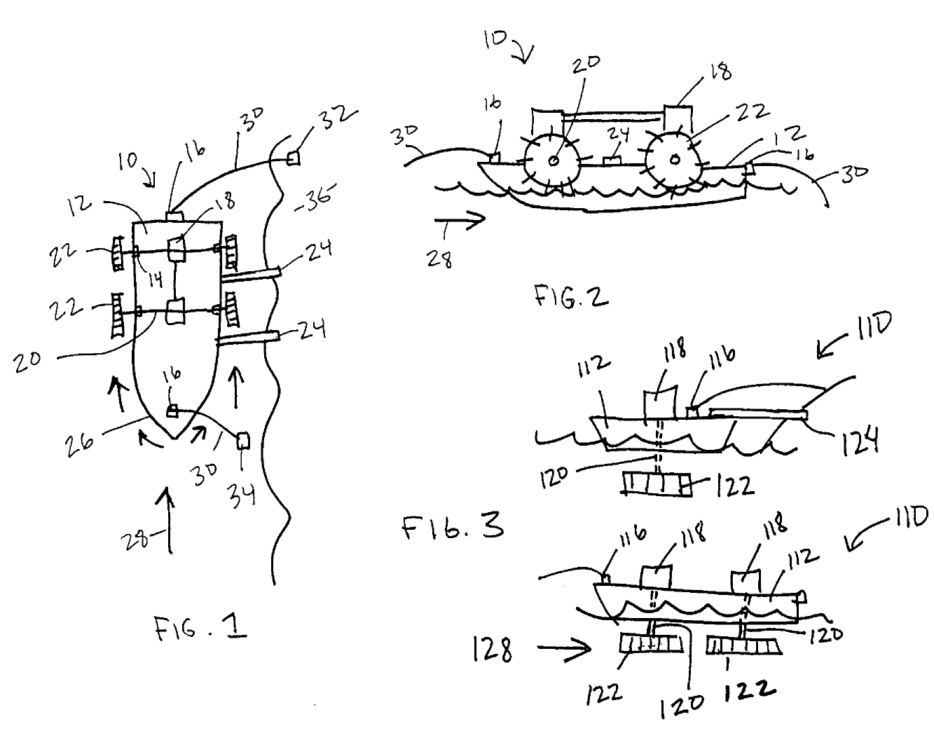

Referring to FIGS. 1-2, there is the power generator barge 10 of the present invention. The barge 10 comprises a boat body 12, having an interior volume with a plurality of rotational mounts 14 and cable anchors 16 on opposite ends thereof. The boat body 12 floats in a body of moving water and may contain means for sailing. As such, the barge 10 may be delivered directly to a remote location or delivered to a remote location as a whole or as pieces to be assembled. The boat body can be a barge or other style of ship. Optional gangplank entry 24 can also be included on the boat body 12, allowing for access into the boat body 12 and the parts housed therein.

There is also a generator 18 mounted on the rotational mounts 14 by a rotatable shaft 20. The rotatable shaft 20 is operatively connected to the generator 18 such that when the shaft 20 rotates, the generator 18 generates electricity. The rotatable shaft 20 extends through the width of the boat body 12. Any rotational generator known to one skilled in the art can be used as the generator 18 of the present invention.

In an alternate embodiment, there are multiple generators, each with corresponding rotatable shafts. The multiple generators are aligned in the boat body 12 with the direction of water flow. These additional generators increase the capacity of the barge 10 of the present invention.

The barge 10 further includes at least one paddle wheel cam 22 fixedly attached to an end of the rotatable shaft 20. Each paddle wheel cam 22 has a diameter extending along a side of the boat body 12, and each paddle wheel cam 22 is positioned against the boat body 12 so as to be capable of rotation in response to water current. The paddle wheel cam 12 must have sufficient size to reach the water surface from the rotational mounts 14.

In an alternate embodiment, there are paddle wheel cams on both sides of the boat body 12 at both ends of the rotatable shaft 20. The plurality of paddle wheel cams increase the efficiency of the small hydro system because the rotation of the shaft 20 is more powerful. Additionally, with multiple generators and multiple paddle wheel cams, the barge 10 can greatly increase the power output from the same water flow. These paddle wheel cams are alternatives the well known turbines with fan blades. With turbines, the water is directed and channeled to push the fan blades for rotation. The present invention avoids such restriction of water flow 28. While being less efficient, the paddle wheel cam 22 are more easily repaired and replaced for isolated communities. Additionally, each paddle wheel cam 22 is aligned with the flow of water, such that the barge generates power without the need for channeling into a turbine fan and overcoming resistance. The present invention is a more passive system, which is less efficient, yet still suitable for smaller applications with less power demand.

The present invention also includes a deflector 26 attached to an end of the boat body 12 facing a direction of the water current 28. The deflector 26 directs flow to the paddle wheel cams 22 for stronger rotation of the shaft 20. The deflector 26 is important to provide more water flow to the paddle wheel cams 22. Compared to the prior art turbines and channeled flow, the more passive system of the present invention requires some adjustments to make the power generation more efficient without too much added structure and complications. There are fewer efficiency concerns with the small hydro system of the present invention, but the deflector 26 is a simple structure to affect some increase in efficiency.

Finally, the boat body 12 includes a plurality of cables 30, each cable 30 having ends attached to the cable anchors 16 of the boat body 12 and opposite ends to an anchor 32 or 34. There are shore anchors 32 and underwater anchors 34, which both function to hold the position of the barge 10 in the moving water 28. The anchors 32 and 34 are important to lock a position so that the force of the water is directed to the paddle wheel cams 22. Importantly, the anchoring cannot be so rigid because the anchors 32 and 34 must account for the rise and fall of water levels in the river. The barge 10 can float on the water surface while maintaining a fixed position laterally relative to the shore 36. The cables 30 can be formed of known materials for mooring ships.

The power generator barge 10 of the present invention provides an apparatus for generating electrical energy relative to the action of water. The hydraulic energy is harnessed by paddle wheel cams 22 kept on the surface by the rotational mounts 14 and kept in place by the cables 30 and anchors 32 and 34. The boat body 12 configuration enables the hydraulically powered generator to be portable and easily installed. The barge 10 can travel to a remote location completely assembled or even delivered as completely assembled. Alternatively, parts can be shipped for construction and installation on site. The barge 10 of the present invention enables under-served populations to receive the benefit of electricity.

The power generator barge 10 also includes the innovation of paddle wheel cams for a small hydro system. In conjunction with the deflector, this small hydro system of the present invention provides an innovative solution to balance the flexibility for less efficient rotation of the shaft, reduction of complicated installations, and the need for some increased efficiency for power generation.

The foregoing disclosure and description of the invention is illustrative and explanatory thereof. Various changes in the details of the described method can be made without departing from the true spirit of the invention.

1. A power generator barge, comprising:
a boat body, having an interior volume with a plurality of rotational mounts and cable anchors on opposite ends thereof
a generator being mounted on said rotational mounts by a rotatable shaft, said rotatable shaft being operatively connected to said generator such that when the shaft rotates, the generator generates electricity;
a paddle wheel cam fixedly attached to an end of said rotatable shaft, said paddle wheel cam having a diameter extending along a side of said boat body, positioned against said boat body so as to be capable of rotation in response to water current;
a deflector being attached to an end of said boat body facing a direction of the water current; and
a plurality of cables, each cable having ends attached to said cable anchors of said boat body and opposite ends to an anchor.

2. The power generator barge according to claim 1, wherein said boat body is a barge.

3. The power generator barge according to claim 1, wherein said boat body has a gang plank entry on a side thereof.

4. The power generator barge according to claim 1, wherein said generator is comprised of a plurality of generators, each generator being aligned with a direction of flow of water current, each generator having a corresponding rotatable shaft, each shaft extending through said boat body.

5. The power generator barge according to claim 4, wherein said paddle wheel is comprised of a plurality of paddle wheels, each rotatable shaft having a corresponding paddle wheel, the paddle wheels being aligned to each other and in a direction of flow of water current.

6. The power generator barge according to claim 1, wherein said paddle wheel is comprised of a plurality of paddle wheels, each rotatable shaft extending through said boat body and having corresponding paddle wheels on opposite ends thereof, the paddle wheels being aligned in flow of water current on opposite sides of said boat body.

7. The power generator barge according to claim 6, wherein each paddle wheel receives water from said deflector generator on both sides of said boat body.

8. The power generator barge according to claim 1, wherein said cables maintain contact with said boat body during vertical displacement and horizontal displacement of said boat body.

9. The power generator barge according to claim 1, wherein said anchors are fixedly positioned underwater.

10. The power generator barge according to claim 1, wherein said anchors are fixedly attached to said cable anchors by mooring.

11. A power generator barge, comprising:
a boat body, having an interior volume with a plurality of rotational mounts and cable anchors on opposite ends thereof.
a plurality of generators, each generator being mounted on said rotational mounts by a rotatable shaft, each rotatable shaft being operatively connected to each generator such that when the shaft rotates, the generator generates electricity;
a plurality of paddle wheel cams fixedly attached to ends of respective rotatable shafts, each paddle wheel cam having a diameter extending along a side of said boat body, positioned against said boat body so as to be capable of rotation in response to water current;
a deflector being attached to an end of said boat body facing a direction of the water current, each paddle wheel cam being aligned with said deflector; and
a plurality of cables, each cable having ends attached to said cable anchors of said boat body and opposite ends to an anchor.

12. The power generator barge according to claim 11, wherein said cables maintain contact with said boat body during vertical displacement and horizontal displacement of said boat body.

13. The power generator barge according to claim 11, wherein said anchors are fixedly positioned underwater.

14. The power generator barge according to claim 11, wherein said anchors are fixedly attached to said cable anchors by mooring.

15. The power generator barge according to claim 1, said paddle wheel cam being positioned underneath said boat body.

16. The power generator barge according to claim 11, said paddle wheel cams being positioned underneath said boat body.
